(19) United States
(12) Patent Application Publication
(10) Pub. No.: US 2025/0145531 A1
(43) Pub. Date: May 8, 2025

(54) METHOD FOR MANUFACTURING TABLETS AND POWDER FOR ECO-FRIENDLY CLAY PREPARATION, TABLETS FOR ECO-FRIENDLY CLAY PREPARATION, AND ECO-FRIENDLY CLAY PREPARED USING SAME

(71) Applicant: THE FLOUR FACTORY INC., Yongin-si, Gyeonggi-do (KR)

(72) Inventor: Bo Gyeong JUNG, Yongin-si, Gyeonggi-do (KR)

(21) Appl. No.: 18/730,686

(22) PCT Filed: Oct. 26, 2023
(86) PCT No.: PCT/KR2023/016710

§ 371 Date: Jul. 19, 2024

(30) Foreign Application Priority Data
Nov. 21, 2022 (KR) 10-2022-0156082

(51) Int. Cl. C04B 33/04; C04B 33/13; C04B 33/132; C04B 33/30

(52) U.S. Cl. CPC C04B 33/04; C04B 33/1305; C04B 33/132; C04B 33/30

(57) ABSTRACT

Embodiments relate to a tablet manufacturing method for preparing eco-friendly clay for crafting or tactile play by using a grain powder or the like, the method comprising: a stirring step of uniformly stirring a mixture containing at least one type of raw material; a molding step of molding the raw material mixture, stirred in the stirring step, into a tablet shape; and a drying step of drying the tablet-shaped mixture, molded in the molding step, to produce tablets.

### TECHNICAL FIELD

The present disclosure relates to a method for manufacturing tablets and powder for eco-friendly clay preparation, tablets and powder for eco-friendly clay preparation, and eco-friendly clay prepared using the same. More specifically, the present disclosure relates to a method for manufacturing tablets and powder for eco-friendly clay preparation, with the tablets and powder to be blended with grain flour, for crafting or tactile play using grain flour, tablets for eco-friendly clay preparation, and eco-friendly clay prepared using the same.

### BACKGROUND ART

Rising oil prices and political and environmental concerns are driving up the cost of grains, and many grains are imported, which has a large carbon footprint, making it difficult to turn inedible materials into play clay.

In addition, importing expired grains that end up being discarded is environmentally detrimental.

Currently, approximately 20 trillion won worth of agricultural and food products are discarded annually in South Korea, with 1.8 trillion won discarded outright after storage.

According to surveys, 94.2% of households have experienced keeping expired grain products such as powdered rice, flour, and starch; 26.5% recycle these products for sensory play or grease removal, while 73.5% dispose of the products as sewage or food waste.

However, disposing of food powder in water or soil may lead to soil and water pollution. Accordingly, there is an increasing need to minimize waste of food product by simply upcycling within households into creative clay for non-hazardous play, rather than disposing of them within the same cycle.

The above-described background technology is technical information that the inventors have held for the derivation of the present disclosure or that the inventors acquired in the process of deriving the present disclosure, and thus, the above-described background technology cannot be regarded as known technology disclosed to the general public prior to the filing of the present disclosure.

### DETAILED DESCRIPTION OF INVENTION

### Technical Problems

In one aspect of the present disclosure, disclosed are a method for manufacturing tablets and powder for eco-friendly clay preparation, tablets and powder for eco-friendly clay preparation, and eco-friendly clay prepared using the same, so that tablet-form products are manufactured to transform various expired grain flours (such as wheat flour, rice flour, starch flour, porridge flour, glutinous rice flour, or frying flour) into clay for crafting or sensory play, thus eliminating carbon footprints during grain clay preparation and enabling food powder materials to be used as materials for crafting and play within the same cycle before disposal, facilitating easy creation of diverse eco-friendly clays of different textures at home is facilitated, and ensuring ease of storage and handling of the clays.

The technical problem of the present disclosure is not limited to the technical problem mentioned above, and other technical problems not mentioned will be clearly understood by those skilled in the art from the description below.

### Technical Solution

A method for manufacturing tablets for eco-friendly clay preparation according to an embodiment of the present disclosure is a method for manufacturing tablets for eco-friendly clay preparation, the tablet to be mixed with grain powders to prepare eco-friendly clay for crafting or tactile play using grain flour or the like, the method including: a stirring step of uniformly stirring a mixture comprising at least one type of raw material; a molding step of molding the mixture of raw material stirred by the stirring step into a tablet shape; and a drying step of drying the tablet-shaped mixture formed by the molding step to manufacture tablets.

In one embodiment, the mixture may contain one or more raw materials selected from a group consisting of salt, edible acid, grain flour, purified water, starch powder, and edible coloring.

In one embodiment, the mixture may contain: 50 to 60 parts by weight of salt as a preservative and hardening agent; 10 to 15 parts by weight of edible acid as a preservative and texture retainer; 15 to 20 parts by weight of grain flour as a binder; 20 to 30 parts by weight of purified water as a solvent; 3 to 10 parts by weight of starch; and 2 to 10 parts by weight of edible coloring.

In one embodiment, the mixture may contain: 55.6 parts by weight of salt as a preservative and hardening agent; 11.1 parts by weight of edible acid as a preservative and texture retainer; 7.4 parts by weight of grain flour as a binder; 18.5 parts by weight of purified water as a solvent; 3.7 parts by weight of starch; and 3.7 parts by weight of edible coloring.

In one embodiment, the edible acid may be one or more selected from a group consisting of L-tartaric acid, citric acid, potassium sorbate, sodium benzoate, sodium propionate, potassium propionate, grapefruit seed extract, and citrus extract.

In one embodiment, the grain powder may be one or more selected from a group consisting of wheat flour, glutinous rice flour, and gelatin powder.

In one embodiment, the method for manufacturing tablets for eco-friendly clay preparation according to another embodiment of the present disclosure may further include, prior to the molding step, an adding lubricant step of adding a pod or capsule containing edible oil for lubrication in a sealed internal space to the mixture stirred by the stirring step.

A tablet for eco-friendly clay preparation according to an embodiment of the present disclosure is manufactured by a method for manufacturing tablets for eco-friendly clay preparation.

Eco-friendly clay according to an embodiment of the present disclosure is manufactured by mixing clay materials with tablets for preparing eco-friendly clay, the tablets manufactured by a method for manufacturing tablets for eco-friendly clay preparation.

Eco-friendly clay according to an embodiment of the present disclosure is prepared by mixing at least four times a weight of grain flour or coffee grounds powder with one tablet for preparation of the eco-friendly clay, and then adding water and edible oil.

### Effect of Invention

According to one aspect of the present disclosure, depending on a type of powder used, it is possible to manufacture clay with various textures and also enable preparation of clay that exhibits elasticity, viscosity, enhanced durability and preservation effects, by using tablets and powder for eco-friendly clay preparation.

The effects of the present disclosure are not limited to those mentioned above and may include various effects within the scope obvious to those ordinarily skilled in the art from the description below.

### BRIEF DESCRIPTION OF THE DRAWING

FIG. 1 is a flowchart explaining a method for manufacturing tablets for eco-friendly clay preparation according to an embodiment of the present disclosure.

FIGS. 2 and 3 are diagrams showing tablets for eco-friendly clay preparation, the tablets manufactured by a method for manufacturing tablets for eco-friendly clay preparation according to an embodiment of the present disclosure.

FIG. 4 is a flowchart explaining a method for manufacturing tablets for eco-friendly clay preparation according to another embodiment of the present disclosure.

FIG. 5 is a flowchart explaining a method for manufacturing powder for eco-friendly clay preparation according to an embodiment of the present disclosure.

FIG. 6 is a view showing powder manufactured and packaged by a method for manufacturing powder for eco-friendly clay preparation according to an embodiment of the present disclosure.

### BEST MODE FOR CARRYING OUT THE PRESENT DISCLOSURE

In the following detailed description, reference is made to the accompanying drawings that show, by way of illustration, specific embodiments in which the present disclosure may be practiced. These embodiments are described in sufficient detail to enable those skilled in the art to practice the present disclosure. It is to be understood that the various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim. In the drawings, like numerals refer to the same or similar functions throughout the several views.

Hereinafter, preferred embodiments of the present disclosure will be described in more detail with reference to the drawings.

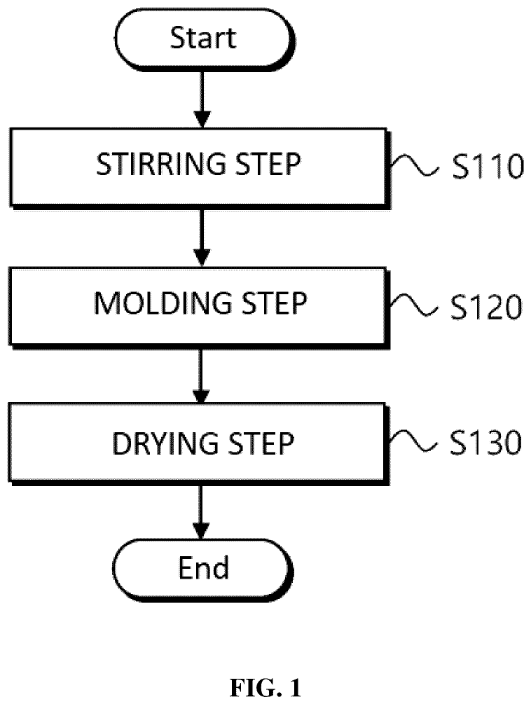

FIG. 1 is a flowchart explaining a method for manufacturing tablets for eco-friendly clay preparation according to an embodiment of the present disclosure.

Referring to FIG. 1, in a method for manufacturing tablets for eco-friendly clay preparation according to an embodiment of the present disclosure, a mixture containing at least one type of raw material is first stirred uniformly (S110) using a stirring device (not shown in the drawing for ease of description).

In one embodiment, the mixture may contain at least one type of raw material selected from a group consisting of salt, edible acid, grain flour, purified water, starch flour, and edible coloring (in powder or gel form).

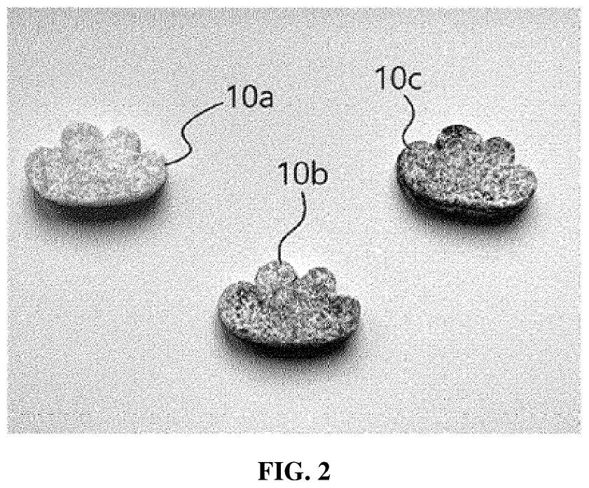

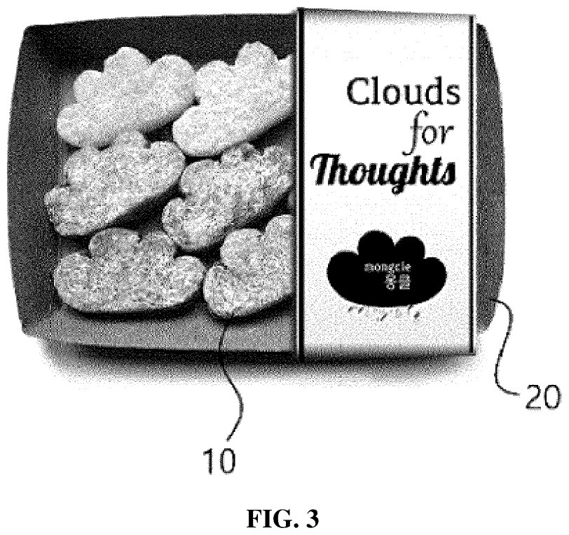

At this time, tablets 10 for eco-friendly clay preparation according to an embodiment of the present disclosure, manufactured by the method for manufacturing tablets for eco-friendly clay preparation, may be implemented in various colors of tablets 10, such as white 10a, green 10b, or blue 10c, as shown in FIG. 2 or FIG. 3, depending on the color of additive edible coloring.

In one embodiment, the mixture may contain: 50 to 60 parts by weight of salt as a preservative and hardening agent; 10 to 15 parts by weight of edible acid as a preservative and texture retainer; 15 to 20 parts by weight of grain flour as a binder; 20 to 30 parts by weight of purified water as a solvent; 3 to 10 parts by weight of starch (for granulation and surface coating); and 2 to 10 parts by weight of edible coloring (in powder or gel form).

In one embodiment, the mixture may contain: 55.6 parts by weight of salt as a preservative and hardening agent; 11.1 parts by weight of edible acid as a preservative and texture retainer; 7.4 parts by weight of grain flour as a binder; 18.5 parts by weight of purified water as a solvent; 3.7 parts by weight of starch (for granulation and surface coating); and 3.7 parts by weight of edible coloring (in powder or gel form).

In one embodiment, the edible acid may be selected from a group consisting of L-tartaric acid, citric acid, potassium sorbate, sodium benzoate, sodium propionate, potassium propionate, grapefruit seed extract, and citrus extract, and then adjusted in ratio.

In one embodiment, the grain flour may be one or more selected from a group consisting of wheat flour, glutinous rice flour, and gelatin powder.

Next, the mixture of raw materials stirred in the stirring step S110 is molded into various tablet shapes (such as a cloud shape as shown in FIG. 2 or 3, a snowman shape, a character shape, or an animal shape) according to the preference of a kid who likes clay using a mold (not shown in the drawing for ease of description) (S120).

The mixture of molded tablet shapes formed in the molding step S120 is dried to manufacture tablets 10 (S130).

The tablets 10 for eco-friendly clay preparation manufactured up to the tablet manufacturing step S130 as described above may be stored and sold in a container 20 as shown in FIG. 3.

Regarding clay which is a composition manufactured using the tablets 10 for eco-friendly clay preparation, the tablets 10 which are manufactured by the method for manufacturing tablets for eco-friendly clay preparation according to an embodiment of the present disclosure, the method having steps as described above, it is possible to manufacture clay with various textures depending on a type of powder used and to enhance elasticity, viscosity, durability, and preservation effects.

Eco-friendly clay manufactured by the method for manufacturing tablets for eco-friendly clay preparation according to an embodiment of the present disclosure, the method having steps as described above, may be stored or sold in various types of a sealed container 20 as shown in FIG. 3

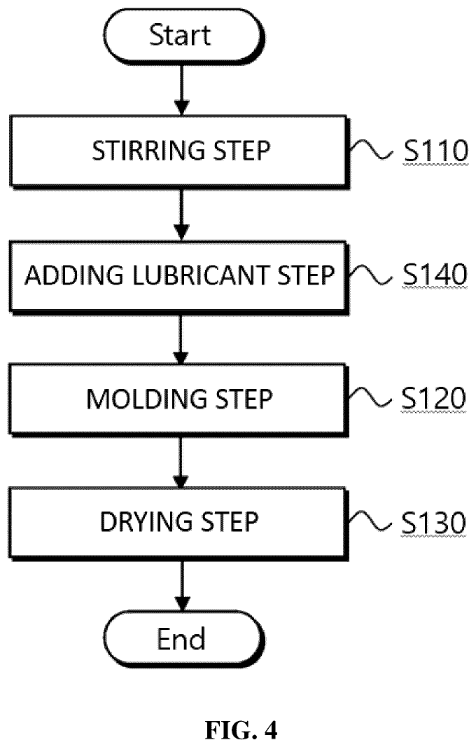

FIG. 4 is a flowchart explaining a method for manufacturing tablets for eco-friendly clay preparation according to another embodiment of the present disclosure.

Referring to FIG. 4, in the method for manufacturing tablets for eco-friendly clay preparation according to another embodiment of the present disclosure, before a molding step S120, a pod or capsule containing edible oil for lubrication in a sealed internal space is added to the mixture stirred by the stirring step S110 (S115).

In doing this, clay which is a composition manufactured using the tablets 10 for eco-friendly clay preparation, the tablets 10 which are manufactured by the method for manufacturing tablets for eco-friendly clay preparation according to an embodiment of the present disclosure, the method having steps as described above, may provide a softer texture than conventional clay.

Eco-friendly clay which is a composition manufactured using the tablets 10 for eco-friendly clay preparation, the tablets 10 which are manufactured by the method for manufacturing tablets for eco-friendly clay preparation according to an embodiment of the present disclosure, the method having steps as described above, may be prepared by combining the tablets for eco-friendly clay preparation with clay materials.

That is, the eco-friendly clay according to the present disclosure may be prepared by mixing at least four times the weight of grain flour or coffee grounds powder with one tablet for eco-friendly clay preparation described in FIGS. 1 to 4, adding water and edible oil to dissolve the tablet for eco-friendly clay preparation, and then mixing the dissolved tablet with the grain flour or coffee grounds powder together.

Hereinafter, a method for manufacturing powder for eco-friendly clay preparation will be described, but overlapping content with the tablet manufacturing method will be omitted.

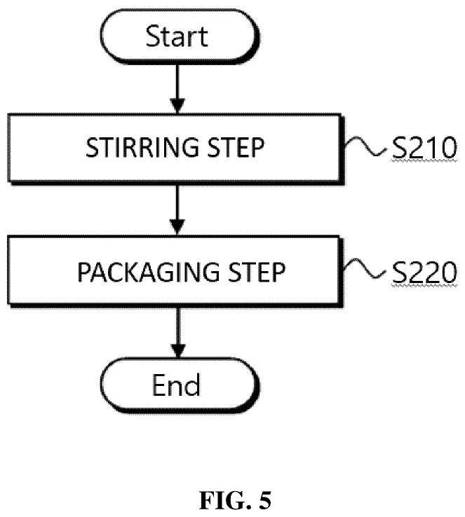

FIG. 5 is a flowchart explaining a method for manufacturing powder for eco-friendly clay preparation according to an embodiment of the present disclosure.

Referring to FIG. 1, in a method for manufacturing powder for eco-friendly clay preparation according to one embodiment of the present disclosure, a mixture is first stirred uniformly using a stirring device (not shown in the drawing for ease of description) (S210).

In one embodiment, the mixture may contain 50 to 65 parts by weight of salt, 10 to 15 parts by weight of edible acid, 10 to 20 parts by weight of grain flour, 3 to 10 parts by weight of starch, and 2 to 10 parts by weight of edible coloring.

In one embodiment, the mixture may contain 62.5 parts by weight of salt, 12.5 parts by weight of edible acid, 12.6 parts by weight of grain flour as a binder, 8.3 parts by weight of starch, and 4.1 parts by weight of edible coloring.

Next, the mixture of raw materials stirred in a stirring step S210 is packaged into a packaging member 220.

A packaging step 220 may be performed with film packaging, but is not limited to this and may be performed in various packaging methods for packaging the mixture.

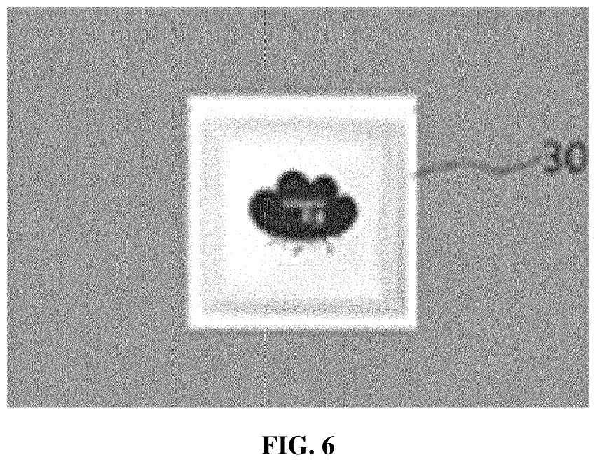

The powder for eco-friendly clay preparation, completely manufactured before the above-described packaging step S220, may be packaged and sold in individual packets as shown in FIG. 6.

The method for manufacturing powder for eco-friendly clay preparation according to an embodiment of the present disclosure may further include a step of drying the mixture before the packaging step 220, and may additionally include a crushing step to uniformly size solid mixtures.

Regarding clay which is a composition manufactured using powder for eco-friendly preparation, the powder manufactured by the method for manufacturing powder for eco-friendly clay preparation according to an embodiment of the present disclosure, the method having steps as described above, it is possible to provide clay with various textures depending on a type of powder used, and to enhance elasticity, viscosity, durability, and preservation effects.

The eco-friendly clay prepared by the method for manufacturing powder for eco-friendly clay preparation according to an embodiment of the present disclosure, having steps as described above, may be stored or sold in various types of a sealed container 20 as shown in FIG. 3.

The eco-friendly clay according to the present disclosure may be prepared by mixing at least four times the weight of grain flour or coffee grounds powder with one packet 30 of powder for eco-friendly clay preparation described in FIGS. 5 and 6, adding water and edible oil to dissolve the powder for eco-friendly clay preparation, and then mixing the dissolved powder with the grain flour or coffee grounds powder together.

The above-described embodiments are intended for illustrative purposes, and it will be understood that those having ordinary knowledge in the art to which the present disclosure pertains can easily make modifications and variations without changing the technical spirit and essential features of the present disclosure. Therefore, the above-described embodiments are illustrative and are not limitative in all aspects. For example, each component described as being in a single form may be practiced in a distributed form, and similarly, components described as being in a distributed form may be practiced in an integrated form.

The scope of protection pursued via the present specification should be defined by the attached claims, rather than the detailed description, and all modifications and variations which can be derived from the meanings, scopes and equivalents of the claims should be construed as falling within the scope of the present disclosure.

1. A method for manufacturing tablets for eco-friendly clay preparation, the tablet to be mixed with grain powders to prepare eco-friendly clay for crafting or tactile play using grain flour or the like, the method comprising:
a stirring step of uniformly stirring a mixture containing at least one type of raw material;
a molding step of molding the mixture of raw material stirred by the stirring step into a tablet shape; and
a drying step of drying the tablet-shaped mixture formed by the molding step to manufacture tablets.

2. The method of claim 1, wherein the mixture contains one or more raw materials selected from a group consisting of salt, edible acid, grain flour, purified water, starch powder, and edible coloring.

3. The method of claim 1, wherein the mixture contains: 50 to 60 parts by weight of salt as a preservative and hardening agent; 10 to 15 parts by weight of edible acid as a preservative and texture retainer; 15 to 20 parts by weight of grain flour as a binder; 20 to 30 parts by weight of purified water as a solvent; 3 to 10 parts by weight of starch; and 2 to 10 parts by weight of edible coloring.

4. The method of claim 1, wherein the mixture contains: 55.6 parts by weight of salt as a preservative and hardening agent; 11.1 parts by weight of edible acid as a preservative and texture retainer; 7.4 parts by weight of grain flour as a binder; 18.5 parts by weight of purified water as a solvent; 3.7 parts by weight of starch; and 3.7 parts by weight of edible coloring.

5. The method of claim 4, wherein the edible acid is one or more selected from a group consisting of L-tartaric acid, citric acid, potassium sorbate, sodium benzoate, sodium propionate, potassium propionate, grapefruit seed extract, and citrus extract.

6. The method of claim 4, wherein the grain powder is one or more selected from a group consisting of wheat flour, glutinous rice flour, and gelatin powder.

7. The method of claim 1, further comprising, prior to the molding step, an adding lubricant step of adding a pod or capsule containing edible oil for lubrication in a sealed internal space to the mixture stirred by the stirring step.

8. A tablet for eco-friendly clay preparation, manufactured by a method for manufacturing tablets for eco-friendly clay preparation according to claim 1.

9. An eco-friendly clay manufactured by mixing a tablet manufactured by the method for manufacturing tablets according to claim 1 with a clay material.

10. The method of claim 9, wherein eco-friendly clay is prepared by mixing at least four times a weight of grain flour or coffee grounds powder with one tablet for preparation of the eco-friendly clay, and then adding water and edible oil.
